(19) United States
(12) Patent Application Publication
(10) Pub. No.: US 2017/0284327 A1
(43) Pub. Date: Oct. 5, 2017

(54) Method For Controlling The Actuator Of The Wastegate Of A Turbocharger Of A Motor Vehicle

(71) Applicant: Continental Automotive GmbH, Hannover (DE)

(72) Inventor: Thomas Burkhardt, Neutraubling (DE)

(73) Assignee: Continental Automotive GmbH, Hannover (DE)

(21) Appl. No.: 15/507,365

(22) PCT Filed: Aug. 4, 2015
(86) PCT No.: PCT/EP2015/067991

§ 371 Date: Feb. 28, 2017

(30) Foreign Application Priority Data
Sep. 2, 2014 (DE) 10 2014 217 456.2

(51) Int. Cl. F02D 41/14; F02D 41/00

(52) U.S. Cl. CPC F02D 41/1402; F02D 41/0007; F02B 37/18

(57) ABSTRACT

The disclosure relates to internal combustion engines. The teachings thereof may be embodied in methods for controlling the actuator of the wastegate of an exhaust gas turbocharger of a motor vehicle. A method for controlling an actuator of the wastegate of an exhaust gas turbocharger of a motor vehicle may include: characterizing the wastegate in a model as a series connection of two throttle points; and actuating the wastegate based on the model.

### CROSS-REFERENCE TO RELATED APPLICATIONS

This application is a U.S. National Stage Application of International Application No. PCT/EP2015/067991 filed Aug. 4, 2015, which designates the United States of America, and claims priority to DE Application No. 10 2014 217 456.2 filed Sep. 2, 2014, the contents of which are hereby incorporated by reference in their entirety.

### TECHNICAL FIELD

The disclosure relates to internal combustion engines. The teachings thereof may be embodied in methods for controlling the actuator of the wastegate of an exhaust gas turbocharger of a motor vehicle.

### BACKGROUND

In combustion engines with turbocharging, the fresh air is compressed by means of a turbocharger before flowing into the cylinders in order to introduce a larger air mass into the cylinder than is possible by suction from the respective ambient pressure. The resulting charging pressure p₂, that is, the pressure after turbocharger compressor, and the air mass flow through the turbocharger compressor are determined by the combination of turbocharger speed and turbocharger power.

### SUMMARY

The present disclosure teaches at least a wastegate model, which, depending on the respective application, is used directly or inverted as an algorithm for controlling the turbocharger, as is explained in greater detail below. The teachings may be embodied in methods for controlling the actuator of the wastegate of an exhaust gas turbocharger of a motor vehicle, characterized in that the control signal is determined by taking into consideration a model, which describes the wastegate as a series connection of two throttle points.

In some embodiments, a characteristic diagram is filed in a memory of the engine control device of the motor vehicle and describes the nominal relationship of annular surface to borehole surface of the wastegate as a function of the pressure relationships at the wastegate and as a function of a nominal mass flow factor.

Some embodiments may include: determining the nominal wastegate exhaust gas mass flow (m_{wg,sp}) at a current operating point during the running time of the exhaust gas turbocharger, determining a nominal mass flow factor (Wₛₚ) belonging to the current operating point by using the determined nominal wastegate exhaust gas mass flow, determining a nominal wastegate-area relationship (Q_{A,sp}), belonging to the current operating point, from the filed characteristic diagram by using the determined nominal mass flow factor, and determining the nominal position (s_{acr,sp}) of the actuator realizing the required nominal wastegate mass flow in the current operating point.

Some embodiments may include: determining a nominal force (F_{p,sp}) on the wastegate plate of the wastegate, determining a nominal actuator pressure (P_{acr,sp}), required for setting a desired charging pressure, from the determined nominal position (S_{acr,sp}) and the determined nominal force (F_{p,sp}), and determining the control signal (u_{wg}) for the actuator by using the nominal actuator pressure determined.

### BRIEF DESCRIPTION OF THE DRAWINGS

FIG. 1 shows a functional sketch of a wastegate actuator which may be used to implement the teachings of the present disclosure;

FIG. 2 shows a functional sketch of an electropneumatic wastegate actuator used to implement the teachings of the present disclosure;

FIG. 3 shows a detail sketch of the wastegate;

FIG. 4 shows a diagrammatic representation of a wastegate as a series connection of two throttle points,

FIG. 5 shows a sketch of the course of the flow coefficients as a function of the pressure relationship at a throttle point,

FIG. 6 shows a sketch to illustrate the course of the flow coefficients and second substitute functions as a function of the pressure relationship at a throttle point,

FIG. 7 shows a three-dimensional sketch of the course of the substitute function φ(π_{R}, π_{B}),

FIG. 8 shows a three-dimensional sketch of the course of the substitute function ψ(π_{R}, π_{B}),

FIG. 9 shows a three-dimensional sketch to illustrate a graphic solution of an equation,

FIG. 10 shows a three-dimensional sketch to illustrate the course of the global stationary pressure relationships over the annular surface of the wastegate as a function of the ratio of pressure before and after the turbine and a wastegate surface ratio and

FIG. 11 shows a three-dimensional sketch to illustrate the course of the mass flow factor as a function of the wastegate area relationship and the ratio of the pressure upstream and downstream from the turbine.

### DETAILED DESCRIPTION

The turbocharger power or turbine output Pₜᵤᵣ is determined by

$${P}_{wg} = {\dot{m}}_{sp} \cdot {T}_{3} [ 1 - {( \frac{{p}_{4}}{{p}_{3}} )}^{\frac{κ - 1}{κ}} ] \cdot {c}_{p} \cdot {η}_{acr} , \qquad ( 1 )$$

with \dot{m}ₜᵤᵣ=turbine mass flow, T₃=exhaust gas temperature upstream from the turbine, p₃=pressure upstream from the turbine, p₄=pressure downstream from the turbine, cₚ=specific heat capacity of the exhaust gas under constant pressure and ηₜᵤᵣ=turbine efficiency.

For turbochargers with a wastegate, the turbine power—and thus, indirectly, the charging pressure and the engine power—are thereby controlled in that the exhaust gas mass flow, occurring in the respective operating point of the internal combustion engine, from the cylinders \dot{m}_{eng}, through a specific opening of the wastegate, which is determined by the wastegate position s_{wg}, is divided into a turbine mass flow \dot{m}ₜᵤᵣ, which, at the respective prevailing pressures and temperatures of equation (1), brings about the required turbocharger power and a wastegate mass flow \dot{m}_{wg}, is bypassed at the turbine and does not contribute to the turbocharger power:

\dot{m}_{eng}=\dot{m}ₜᵤᵣ+\dot{m}_{wg}. (2)

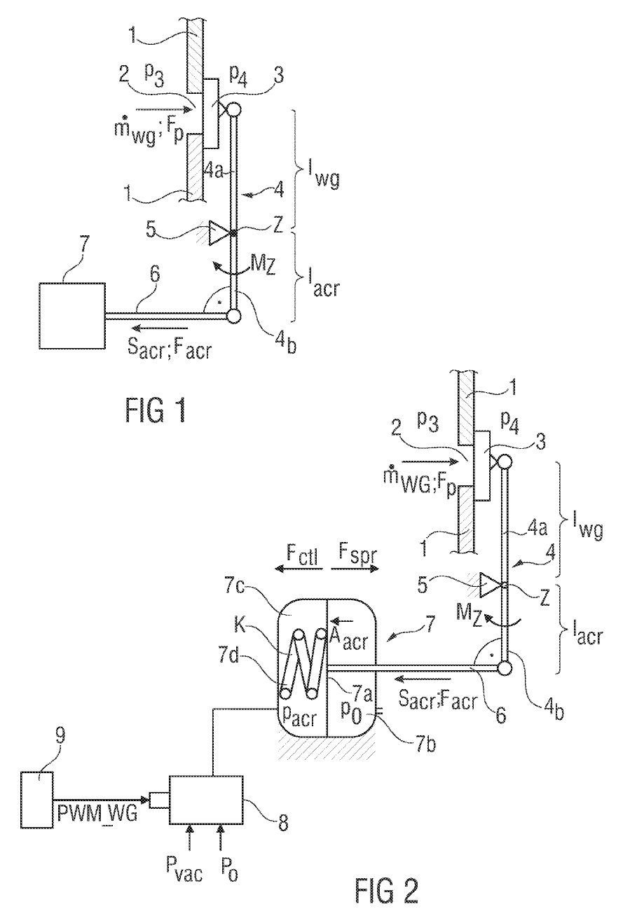

FIG. 1 shows a functional sketch of a wastegate actuator which may be used to implement the teachings of the present disclosure. In FIG. 1, the following are illustrated: a wastegate bore 2 in the turbine housing 1, which is closed off on its right side by a wastegate plate 3, the pressure p₃ upstream from the turbine, the pressure p₄ downstream from the turbine, the exhaust gas mass flow \dot{m}_{wg} through the wastegate, the force Fₚ acting on the wastegate plate due to the pressure difference at the wastegate plate, a wastegate lever 4, which is mounted in an axis of rotation Z, and has a wastegate-side arm 4a of the length l_{wg} and an actuator-side arm 4b of length l_{acr}, and a wastegate actuator rod 6 in a position s_{acr}, on which an actuator 7 acts with an actuator force F_{acr}. Forces opening the wastegate and moments are defined as positive.

The wastegate position is controlled via a lever mechanism by a wastegate actuator, which is actively controlled by the engine control device. It is customary to combine a pre-control of the wastegate actuator, which is calculated on the basis of the desired charging pressure p_{2,sp}, with a charging pressure control to minimize the charging pressure difference

Δp₂=p_{2,sp}−p₂ (3):

u_{wg}=u_{wg,opl}(p_{2,sp})+u_{wg,cll}(p_{2,sp}−p₂), (4)

with u_{wg}=Wastegate control, u_{wg,opl}(p_{2,sp})=Wastegate pre-control and u_{wg,cll}(p_{2,sp}−p₂)=Signal to the charging pressure controller output.

Accurate control of the waste gate may provide a rapid and accurate realization of the required engine torque. If the vibrations excited by the pulsating exhaust gas mass flow are neglected, the wastegate position s_{wg} is constant exactly then, that is, the wastegate is in a stationary state, if the torques, which act upon the wastegate lever mounted to rotate about the wastegate axis Z, add up to 0, that is

Σ(M_{Z})=Mₚ+M_{acr}=0, (5)

with Mₚ=the torque caused by the pressure difference at the wastegate plate, and M_{acr}=torque caused by the actuator.

In systems with positional measurement of the wastegate actuator, the control of the wastegate for setting this torque equilibrium and thus the desired charging pressure is realized as a two-stage control with: an external control circuit for setting the desired charging pressure by means of a preset of the nominal position of the wastegate actuator s_{acr,sp}

s_{acr,sp}=s_{acr,opl}(p_{2,sp})+s_{acr,cll}(p_{2,sp}−p₂), (6)

with s_{acr,opl}(p_{2,sp})=the pre-control of the wastegate position and s_{acr,cll}(p_{2,sp}−p₂)=the charging pressure controller output;
and an internal control circuit for adjusting the nominal wastegate position required

u_{wg}=u_{wg,opl}(s_{acr,sp})+u_{wg,cll}(s_{acr,sp}−s_{acr}), (7)

with u_{wg}=wastegate control u_{wg,opl}(s_{acr,sp})=wastegate pre-control and u_{wg,cll}(s_{acr,sp}−s_{acr})=signal to the position controller output.

In systems without position measurement of the wastegate actuator, the actuator position is not known.

FIG. 2 shows a functional sketch of an electropneumatic wastegate actuator used to implement the teachings of the present disclosure. The wastegate actuator may include: a wastegate borehole 2 in the turbine housing 1, closed from the right by the wastegate plate 3; the pressure p₃ upstream from the turbine; the pressure p₄ downstream from the turbine; the exhaust gas mass flow \dot{m}_{wg} through the wastegate; the force Fₚ acting on the wastegate plate due to the pressure difference at the wastegate plate; a wastegate lever 4, which is mounted in the axis of rotation Z and has a wastegate-side arm 4a of the length l_{wg} and an actuator-side arm 4b of length l_{acr}, as well as a wastegate actuator rod 6 in a position s_{acr}, on which the actuator acts with an actuator force F_{acr}.

In FIG. 2, an electropneumatic reduced pressure wastegate actuator without flow is shown as an example of the execution of a wastegate actuator without position measurement. As depicted, the actuator may include an electropneumatic 3-way valve 8, which, depending on the control PWM_WG (=u_{wg} in the sense of equation (4)) sets an actuator pressure p_{acr} between the ambient pressure p₀ and the reduced pressure p_{vac}, a pneumatic pressure nozzle 7 with a membrane 7a of the active area A_{acr}, the membrane 7a being connected with the actuator rod 6, two chambers 7b and 7c separated by the membrane 7a. The first actuator chamber 7b is connected with the ambient pressure p₀ and the second actuator chamber 7c with the control pressure p_{acr}, which is separated from the surroundings, here for a reduced pressure actuator with p_{acr}<p₀, as well as an actuator spring 7d with a spring constant k.

The pressure difference at the membrane 7a results in the control pressure acting on the actuator rod

F_{acr}=A_{acr}·(p₀−p_{acr}). (8)

The deformation of the spring, into the actuator position s_{acr}, results in the spring force, which acts on the actuator rod

Fₛₚᵣ=k·s_{acr}+F_{spr,0} (9)

with F_{spr,0}=the pretension of the spring at s_{acr}=0.

In the configuration shown in FIG. 2, the magnitude of the spring force Fₛₚᵣ closing the wastegate increases with the increasing actuator position s_{acr}. With that, the spring constant is negative. The control force and the spring force add up to the actuator force F_{acr}:

$$\begin{matrix}{F}_{acr} = {F}_{acr} + {F}_{acr} \\ = {A}_{acr} \cdot ( {p}_{0} - {p}_{acr} ) + k \cdot {s}_{acr} + {F}_{acr , B}\end{matrix} \qquad ( 10 )$$

Other embodiments of the electropneumatic wastegate actuator, for example, with an arrangement of the actuator spring in the other chamber or another switching valve or a subjection of the switching valve to other pressures, may only change the amount and possibly the sign of the forces under consideration. The physical dependencies are the same as in the embodiment depicted.

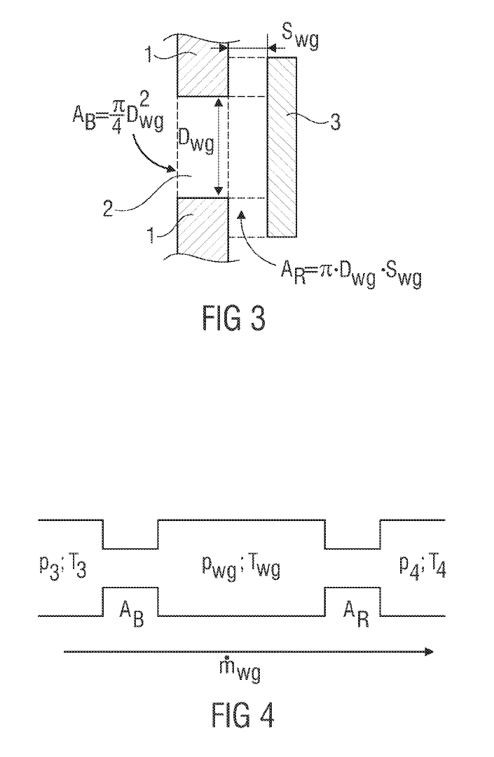

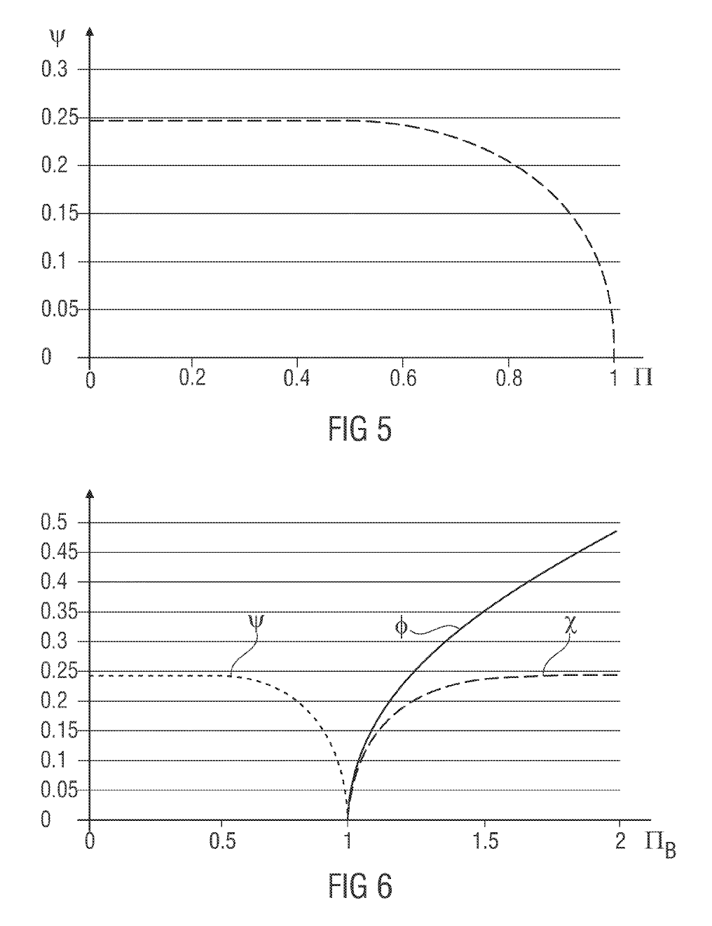

FIG. 3 shows a detail sketch of the wastegate. From FIG. 3, the turbine housing 1 with the wastegate borehole 2 of constant diameter D_{wg} and constant cross-sectional area can be seen. The following applies:

$${A}_{B} = \frac{π}{4} \cdot {D}_{wg}^{2} \qquad ( 11 )$$

To the right of the turbine housing 1, the wastegate plate 3, which is at a distance S_{wg} from the stop on the turbine housing, is shown. In this case, to simplify matters, it is assumed that the movement of the wastegate plate takes place rectilinearly in the direction of the axis of the wastegate borehole. The following applies:

$${s}_{wg} = {s}_{acr} \cdot \frac{{I}_{wg}}{{I}_{acr}} \qquad ( 12 )$$

Between the turbine housing 1 and the wastegate plate 3, there is shown a cylinder-shaped annular surface, which is envisaged as an extension of the wastegate borehole,

$${A}_{R} = π \cdot {D}_{wg} \cdot {s}_{wg} = π \cdot \frac{{I}_{wg}}{{I}_{acr}} \cdot {s}_{acr} \qquad ( 13 )$$

through which the wastegate mass flow is discharged after flowing through the wastegate borehole. The pressure difference at the wastegate plate exerts a force Fₚ on the wastegate plate and a moment on the wastegate lever:

Mₚ=Fₚ·l_{wg} (14).

The actuator force F_{acr}, as the sum of the control force F_{ct1} and the spring force Fₛₚᵣ exerts, according to equation (10), a moment on the wastegate lever of

$$\begin{matrix}{M}_{acr} = {F}_{acr} \cdot {I}_{acr} = ( {F}_{acr} + {F}_{spr} ) \cdot {I}_{acr} \\ = {A}_{acr} \cdot ( {p}_{0} - {p}_{acr} ) \cdot {I}_{acr} + ( k \cdot {s}_{acr} + {F}_{spr , 0} ) \cdot {I}_{acr}\end{matrix} . \qquad ( 15 )$$

By inserting equations (14) and (15) in equation (5), the following results:

0=Fₚ−l_{wg}+A_{acr}·(p₀−p_{acr})·l_{acr}+(k·s_{acr}+F_{spr,0})·l_{acr} (16).

The membrane area A_{acr}, the lever arm lengths l_{acr}, l_{wg}, the spring constants k and the spring pre-tension F_{spr,0} are system constants. The slowly changing ambient pressure is known in the engine control device. Thus, equation (16) describes a stationary equilibrium state between the variable force Fₚ(p₃,p₄,s_{acr}) at the wastegate plate, the actuator position s_{acr} and the control pressure p_{acr}(p₀,p_{vac},u_{wg}), which can be affected directly by the control u_{wg}.

In systems that do not measure the actuator position, the task of pre-control of the wastegate for setting the desired charging pressure can be formulated as follows: For currently occurring pressures p₃ upstream from the turbine and p₄ downstream from the turbine, the wastegate control u_{wg} may be selected so the control pressure p_{acr,sp} compensates all other moments acting on the wastegate lever exactly in the nominal wastegate actuator position s_{acr,sp} necessary for setting the desired charging pressure. The following applies:

$${u}_{wg} = f ( {p}_{acr , sp} ) \\ {p}_{acr , sp} = {p}_{0} + {F}_{p} ( {p}_{3} , {p}_{4} , {s}_{acr , sp} ) \cdot \frac{{I}_{wg}}{{A}_{acr} \cdot {I}_{acr}} + \frac{k \cdot {s}_{acr , sp} + {F}_{spr , a}}{{A}_{acr}} . \qquad ( 17 )$$

This equation (17) cannot be solved directly according to the nominal wastegate or actuator position. Each wastegate pre-control is an approximation of the function described with equation (17), independently of whether it is described analytically in the engine control device or approximated with characteristic diagrams over several input parameters.

The nominal control pressure p_{acr,sp} may be stored as a wastegate pre-control in a memory, the essential inputs of which are the nominal values derived from the desired charging pressure for the pressure upstream from the turbine and the mass flow through the wastegate. The parameters of actuator position and force at the wastegate plate, crucial for a physical description, are not typically used.

Starting from this point, however, the teachings of the present disclosure provide an improved method for controlling the actuator of the wastegate of an exhaust gas turbocharger of a motor vehicle. In some embodiments, a wastegate model may be used directly or inverted as an algorithm for controlling the turbocharger, as is explained in greater detail in the following

A wastegate model or forward model is from this point on one which is determined from a known position S_{acr} of the wastegate actuator using pressures and temperatures of the exhaust gas mass flow m_{wg} flowing through the wastegate, assumed to be known, and the force Fₚ acting on the wastegate plate due to the pressure difference at the wastegate plate.

The model describes the wastegate as a system of two throttle points, connected in series, through which in the stationary state of the same the exhaust gas mass flow flows. This is shown in FIG. 4, which shows a diagrammatic representation of the wastegate as a series connection of two throttle points.

FIG. 4 illustrates a constant borehole surface A_{B} and an annular surface A_{R} of the wastegate, which depends on the actuator position s_{acr}. The wastegate mass flow \dot{m}_{wg} is the same for both throttle points and flows first through the borehole surface A_{B} and then through the annular surface A_{R} of the wastegate. An exhaust gas manifold pressure p₃ and an exhaust gas manifold temperature T₃ exist upstream from the wastegate. An exhaust gas pressure p₄ which is less than p₃ and an exhaust gas temperature T₄ exist downstream from the wastegate.

Between the borehole surface and the annular surface is a temperature referred to hereinafter as the internal wastegate temperature T_{wg}. Since the temperature of the gas, when throttled, changes only very little, it is assumed hereinafter that the exhaust gas manifold temperature T₃ also exists between the borehole surface and the annular surface.

The pressure drop from p₃ to p₄, which can be measured over the whole of the wastegate, is distributed over the two throttle points, depending on the actuator position. Between the borehole surface and the annular surface, a pressure therefore exists which is referred to hereinafter as internal wastegate pressure p_{wg}, for which the following relationship applies:

p₃>p_{wg}>p₄.

As a simplification, it is assumed that this internal wastegate pressure p_{wg} acts uniformly over the whole of the side of the wastegate plate 3, facing the turbine housing with the surface A_{B}. Furthermore, it is assumed that the pressure p4, downstream from the turbine, acts uniformly on the whole of the other side of the wastegate plate 3 with the surface A_{B}. The force Fₚ, introduced in FIG. 2 and acting on the wastegate plate due to the pressure difference at the wastegate plate, can thus be described as

$$\begin{matrix}{F}_{p} = {A}_{B} \cdot ( {p}_{wg} - {p}_{4} ) \\ = \frac{π}{4} \cdot {D}_{wg}^{2} \cdot ( {p}_{wg} - {p}_{4} )\end{matrix} \qquad ( 18 )$$

A gas mass flow \dot{m} through a throttle generally is described with the throttle equation

$$\dot{m} = A \cdot {s}_{sp} \cdot \sqrt{\frac{2 \cdot κ}{( κ - 1 ) \cdot R \cdot {T}_{up}}} \cdot Ψ ( \frac{{p}_{down}}{{p}_{up}} ) \qquad ( 19 )$$

with Tᵤₚ=the temperature upstream from the throttle point, pᵤₚ=the pressure upstream from throttle point, p_{down}=the pressure downstream from throttle point, κ=the isoentropic exponent, R=cₚ−cᵥ=the specific gas constant, cₚ=the specific heat capacity of the gas at constant pressure and cᵥ=the specific heat capacity of the gas at constant volume.

The following generally applies for the pressure relationship at the throttle point:

$$Π = \frac{{p}_{down}}{{p}_{up}} \qquad ( 20 )$$

wherein p_{down} is the pressure downstream from throttle point and pᵤₚ the pressure upstream from the throttle point.

Moreover, the following is the relationship for the flow coefficients at the throttle point for Π<0.53, that is, a supercritical pressure relationship

$$Ψ ( Π ) = \{ \begin{matrix}{( \frac{2}{κ + 1} )}^{\frac{1}{κ + 1}} \sqrt{\frac{κ - 1}{κ + 1}} \\ \sqrt{{( \frac{{p}_{down}}{{p}_{up}} )}^{\frac{2}{x}} - {( \frac{{p}_{down}}{{p}_{up}} )}^{\frac{x + 1}{x}}}\end{matrix} \qquad ( 21 )$$

Applied to the constant borehole surface, the throttle equation describes the wastegate mass flow \dot{m}_{wg} as

$${\dot{m}}_{wg} = {A}_{B} \cdot {p}_{3} \cdot \sqrt{\frac{2 \cdot κ}{( κ - 1 ) \cdot R \cdot {T}_{3}}} \cdot Ψ ( \frac{1}{{Π}_{B}} ) , \qquad ( 22 )$$

wherein the following relationship applies for the ratio of pressure upstream from the borehole surface to the pressure downstream from the borehole surface:

$${Π}_{B} = \frac{{p}_{3}}{{p}_{wg}} > 1.$$

Applied to the wastegate position-dependent annular surface, the throttle equation describes the wastegate mass flow \dot{m}_{wg} as:

$${\dot{m}}_{wg} = {A}_{B} ( {s}_{acr} ) \cdot {p}_{wg} \cdot \sqrt{\frac{2 \cdot κ}{( κ - 1 ) \cdot R \cdot {T}_{3}}} \cdot Ψ ( {Π}_{R} ) , \\ with \text{:} {Π}_{R} = \frac{{p}_{4}}{{p}_{wg}} < 1 = the ratio of the pressure up to upstream from the annular surface to that upstream from the annular surface . \qquad ( 23 )$$

The equations (22) and (23) describe the same wastegate mass flow \dot{m}_{wg} and can be regarded as equivalent:

$${\dot{m}}_{wg} = {A}_{B} \cdot {p}_{3} \cdot \sqrt{\frac{2 \cdot κ}{( κ - 1 ) \cdot R \cdot {T}_{3}}} \cdot Ψ ( \frac{1}{{Π}_{B}} ) = {A}_{B} ( {s}_{acr} ) \cdot {p}_{wg} \cdot \sqrt{\frac{2 \cdot κ}{( κ - 1 ) \cdot R \cdot {T}_{3}}} \cdot Ψ ( {Π}_{R} ) \qquad ( 24 )$$

After both sides are divided by the root, the relationship between the surfaces and pressures at the wastegate follows therefrom:

$${A}_{B} \cdot {p}_{3} \cdot ( \frac{1}{{Π}_{B}} ) = {A}_{s} ( {s}_{acr} ) \cdot {p}_{wg} \cdot Ψ ( {Π}_{R} ) . \qquad ( 25 )$$

Using equations (11)-(13), the wastegate surface ratio is defined as

$${Q}_{A} ( {s}_{acr} ) = \frac{{A}_{E} ( {s}_{acr} )}{{A}_{B}} = \frac{π \cdot {D}_{wg} \cdot \frac{{I}_{wg}}{{I}_{acr}} \cdot {s}_{acr}}{\frac{π}{4} \cdot {D}_{wg}^{2}} = \frac{4 \cdot {I}_{wg}}{{I}_{acr} \cdot {D}_{wg}} \cdot {s}_{acr} . \qquad ( 26 )$$

By dividing by A_{B}·P_{wg} and by substituting according to equations (22) and (26), the following results from equation (25):

$$\frac{{p}_{3}}{{p}_{wg}} \cdot Ψ ( \frac{1}{{Π}_{B}} ) = \frac{{A}_{B} ( {s}_{acr} )}{{A}_{B}} \cdot Ψ ( {Π}_{B} ) \\ {Π}_{B} \cdot Ψ ( \frac{1}{{Π}_{B}} ) = {Q}_{A} ( {s}_{acr} ) \cdot Ψ ( {Π}_{R} ) \qquad ( 27 )$$

The left side of the equation (27) is a function solely of the pressure relationship at the borehole surface Π_{B}. Substitute functions X(Π_{B}) and Φ(Π_{B}) are defined for this term:

$$X ( {Π}_{B} ) = Ψ ( \frac{1}{{Π}_{B}} ) \\ Φ ( {Π}_{B} ) = {Π}_{B} \cdot X ( {Π}_{R} ) = {Π}_{B} \cdot Ψ ( \frac{1}{{Π}_{B}} ) . \qquad ( 28 )$$

Using the substitute function Φ(Π_{B}), equation (27) assumes the following form:

Φ(Π_{B})=Q_{A}(s_{acr})·Ψ(Π_{R}), (29)

The left side of the equation (29) is a function solely of the pressure relationship at the borehole surface. The right side of the equation (29) is for a particular actuator position s_{acr}, that is, for a particular value of the surface ratio Q_{A}(s_{acr}) as a parameter, a function solely of the pressure relationship at the annular surface. Nevertheless, both sides can be portrayed as functions of the two pressure relationships, each of the functions being constant over a pressure relationship.

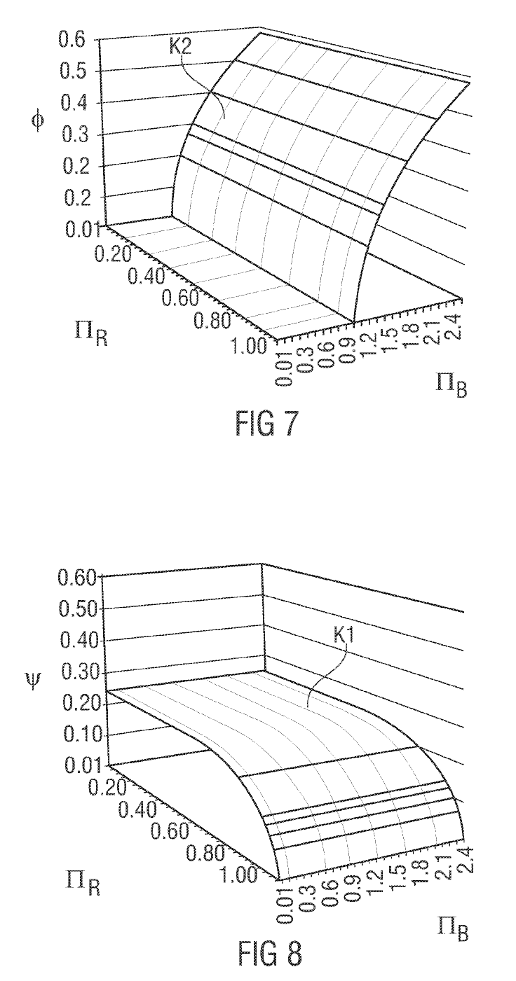

The coordinates [Π_{R},Π_{B}] of the intersection of the two surfaces, shown in FIGS. 7 and 8, are the solutions of equation (27) for Q_{A}(s_{acr})=1. Analogously, the coordinates [Π_{R},Π_{B}] of the intersection of the Φ(Π_{R},Π_{B}) surface, shown in FIG. 7, with the Ψ(Π_{R},Π_{B}) surface shown in FIG. 8 and scaled by an arbitrary surface ratio Q_{A}(s_{acr})>0, are the solutions of the equation (27) for this arbitrary surface factor.

Therefore, the coordinates [Π_{R},Π_{B}] of the intersection, so found and dependent exclusively on the surface ratio Q_{A}(s_{acr}), describe all combinations of pressure relationships at the borehole surface and the annular surface of the wastegate possible for this given actuator position s_{acr}.

From the definition of the pressure relationships at the borehole surface and the annular surface of equations (22) and (23), it follows that:

$$\frac{{Π}_{B}}{{Π}_{R}} = \frac{\frac{{p}_{3}}{{p}_{wg}}}{\frac{{p}_{4}}{{p}_{wg}}} = \frac{{p}_{3}}{{p}_{4}} = tan ( α ) .. \qquad ( 30 )$$

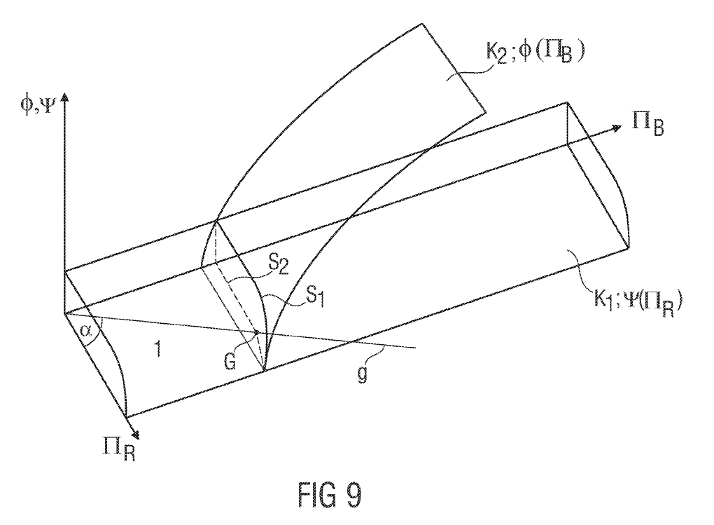

With that, for a certain stationary combination of pressures p3 upstream from the turbine and p4 downstream from the turbine, the ratio of all possible combinations of the pressure relationships at the borehole surface and the annular surface of the wastegate is constant, that is, all possible combinations of the pressure relationships form a straight line g, which passes through the coordinate origin and is drawn in FIG. 9, in the [Π_{R},Π_{B}] plane, which is inclined against the

Π_{R} axis by the angle

$$α = arctan ( \frac{{Π}_{B}}{{Π}_{R}} ) .$$

With that, the coordinates [Π_{R},Π_{B}] of the straight line, which are so found and dependent exclusively on the pressure relationship

$$\frac{{p}_{3}}{{p}_{4}} ,$$

describe all possible combinations of the pressure relationships at the borehole surface and the annular surface of the wastegate possible for this given turbine pressure relationship

$$\frac{{p}_{3}}{{p}_{4}} .$$

The pressure downstream from the wastegate is always smaller than the pressure upstream from the wastegate, that is, p₃>p₄. From this it follows that

$$\frac{{p}_{3}}{{p}_{4}} = tan ( α ) > 1 ⇒ α > 45 ° . \qquad ( 31 )$$

FIG. 9 shows a graphic solution of the equation (27) for a surface ratio Q_{A}(s_{acr})<1, namely the intersection S1 of the left side of the equation, which is illustrated by the K1 formation (see also FIG. 8), and of the right side of the equation, which is illustrated by the K2 formation (see also FIG. 7). The projection of the intersection S1 onto the [Π_{R},Π_{B}] plane, which is illustrated by the broken line S2, is the quantity of all combinations of pressure relationships at the borehole surface and the annular surface possible for this Q_{A}(s_{acr}).

With that, the straight line has always exactly one point of intersection G=[Π_{R},Π_{B}] with the projection of the intersection onto the Π[_{R},Π_{B}] plane, that is, the coordinates of the point of intersection G=[Π_{R},Π_{B}] are the only solution of the equation system, which is formed from equations (27) and (30).

$${Π}_{s} \cdot Ψ ( \frac{1}{{Π}_{R}} ) = {Q}_{A} ( {s}_{acr} ) \cdot Ψ ( {Π}_{R} ) \\ {Π}_{R} = \frac{{p}_{3}}{{p}_{4}} \cdot {Π}_{R} \qquad ( 32 )$$

and the equation with Π_{R} as single variable obtained therefrom by the elimination of Π_{B}.

$$\frac{{p}_{3}}{{p}_{4}} \cdot {Π}_{R} \cdot Ψ ( \frac{{p}_{4}}{{p}_{3} \cdot {Π}_{R}} ) = {Q}_{A} ( {s}_{acr} ) \cdot Ψ ( {Π}_{R} ) \qquad ( 33 )$$

This equation (33) can thus be solved numerically for any combinations of

$$\frac{{p}_{3}}{{p}_{4}} > 1$$

Q_{A}(s_{acr})>0. This solution, with the successful modeling simplification of the wastegate as a series connection of two throttle points and the disregard of the pulsation of the exhaust gas mass flow, is valid globally for all wastegate turbochargers in all stationary operating points.

The stationary pressure relationships, so determined over the annular surface of the wastegate

$${Π}_{R , acr} ( \frac{{p}_{3}}{{p}_{4}} , {Q}_{A} ) ,$$

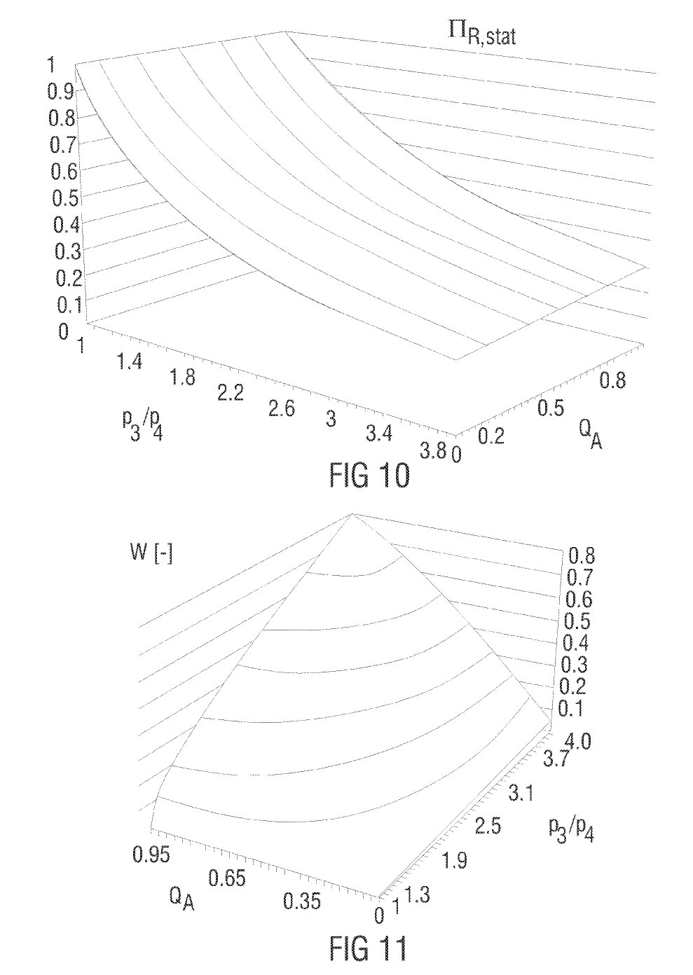

are filed as a constant characteristic diagram in the engine control device. FIG. 10 shows the global stationary pressure relationship over the annular surface of the wastegate

$${Π}_{R , acr} ( \frac{{p}_{3}}{{p}_{4}} , {Q}_{A} ) .$$

To sum up, at the running time in the engine control device, the exhaust gas mass flow can be calculated by the wastegate \dot{m}_{wg} from the constant wastegate borehole diameter D_{wg}, the constant wastegate lever lengths l_{wg},l_{acr}, the constant isoentropic exponent κ, the constant specific gas constant R of the exhaust gas, the current position of the wastegate actuator S_{acr}, the current pressure p₃ upstream from the turbine, the current pressure p₄ downstream from the turbine and the current temperature T₃ upstream from the turbine.

The borehole surface of the wastegate is constantly calculated for all operating points from equation (11)

$${A}_{B} = \frac{π}{4} \cdot {D}_{wg}^{2} .. \qquad ( 34 )$$

From the current position of the wastegate actuator s_{acr}, the current annular surface follows according to equations (12) and (13)

$${A}_{R} = π \cdot {D}_{wg} \cdot {s}_{acr} = π \cdot {D}_{sp} \cdot \frac{{I}_{wg}}{{I}_{acr}} \cdot {s}_{acr} . \qquad ( 35 )$$

The wastegate surface ratio follows from equation (26)

$${Q}_{A} = \frac{{A}_{R}}{{A}_{B}} . \qquad ( 36 )$$

The stationary pressure relationship over the annular surface of the wastegate Π_{R} is read from the stored characteristic diagram

$${Π}_{R} = {Π}_{R , acr} ( \frac{{p}_{3}}{{p}_{4}} , {Q}_{A} ) . \qquad ( 37 )$$

According to equation (23), the internal wastegate pressure p_{wg} is:

$${p}_{wg} = \frac{{p}_{4}}{{Π}_{R}} . \qquad ( 38 )$$

According to equation (18) the force on the wastegate plate resulting therefrom is

$${F}_{p} = \frac{π}{4} \cdot {D}_{wg}^{2} \cdot ( {p}_{wg} - {p}_{4} ) . \qquad ( 39 )$$

According to equation (23), the current waste gas mass flow finally is

$${\dot{m}}_{wg} = {A}_{R} \cdot \sqrt{\frac{2 \cdot κ}{( κ - 1 ) \cdot R \cdot {T}_{3}}} \cdot {ρ}_{wg} \cdot Ψ ( {Π}_{R} ) . \qquad ( 40 )$$

The wastegate forward model in the engine control device may be used for turbochargers, which are equipped with both variable turbine geometry (VTG), as the main actuator, as well as with a wastegate as an auxiliary actuator. For VTG turbochargers without wastegate, all the exhaust gas mass flow of the engine is passed through the turbine. With that, the exhaust gas mass flow, available at the turbine, is known for the calculation of the VTG control. For VTG turbochargers with an additional wastegate, it is possible to calculate according to equation (2) the portion of the exhaust gas mass flow of the engine, which is available for a selected actuator position s_{acr} at the turbine:

\dot{m}ₜᵤᵣ=\dot{m}_{eng}−\dot{m}_{wg}(s_{acr}) (41).

The further calculation of the VTG control can then be carried out as for VTG turbochargers without an additional wastegate.

A model is referred to in the following as an inverse wastegate model (backwards model), which, using pressures and temperatures from a nominal exhaust gas mass flow through the wastegate \dot{m}_{wg,sp}, assumed to be known, determines the nominal position of the wastegate actuator s_{acr,sp} and the nominal force on the wastegate plate F_{p,sp} required for the realization of the wastegate \dot{m}_{wg,sp}.

For typical wastegate turbochargers without a variable turbine geometry, according to equation (2) and starting out from the current exhaust gas mass flow through the engine \dot{m}_{eng} and the nominal exhaust gas mass flow through the turbine m_{tur,sp} resulting from the driver's request, a nominal exhaust gas mass flow through the wastegate \dot{m}_{wg,sp} is calculated:

\dot{m}_{wg,sp}=\dot{m}_{eng}−\dot{m}_{tur,sp} (42).

The throttle equation (23) for the annular surface is analogously valid for nominal values:

$${\dot{m}}_{wg , sp} = {A}_{R , sp} ( {s}_{acr , sp} ) \cdot {p}_{wg , sp} \cdot \sqrt{\frac{2 \cdot κ}{( κ - 1 ) \cdot R \cdot {T}_{3}}} \cdot Ψ ( {Π}_{R , sp} ) . \qquad ( 43 )$$

The nominal value of the internal wastegate pressure is according to equation (23), the nominal annular surface replaced according to equation (26):

$${\dot{m}}_{wg , sp} = {Q}_{A , sp} ( {s}_{acr , sp} ) \cdot {A}_{B} \cdot \frac{{p}_{4}}{{Π}_{R , sp}} \cdot \sqrt{\frac{2 \cdot κ}{( κ - 1 ) \cdot R \cdot {T}_{3}}} \cdot Ψ ( {Π}_{R , sp} ) . \qquad ( 44 )$$

Rearranging results in the following:

$${Q}_{A , sp} ( {s}_{acr , sp} ) \cdot \frac{Ψ ( {Π}_{R , sp} )}{{Π}_{R , sp}} = \frac{{\dot{m}}_{wg , sp}}{{A}_{B} \cdot {p}_{4} \cdot \sqrt{\frac{2 \cdot κ}{( κ - 1 ) \cdot R \cdot {T}_{3}}}} = {W}_{sp} . \qquad ( 45 )$$

The equation (45) is to be understood as implying that, for a required nominal exhaust gas mass flow through the wastegate \dot{m}_{wg,sp} at a known pressure p₄ downstream from the turbine and at a known temperature T₃ upstream from the turbine, a combination of wastegate surface ratio Q_{A,sp}(s_{acr,sp}) and pressure relationship at the annular surface of the wastegate Π_{R,sp}, bringing about this mass flow, is to be found. The parameter, defined in equation (45) is referred to as nominal mass flow factor Wₛₚ.

The stationary pressure relationship over the annular surface of the wastegate is filed as characteristic diagram over the turbine pressure relationship

$$\frac{{p}_{3}}{{p}_{4}}$$

and the wastegate surface ratio Q_{A} (see equation (37)). For each point of this characteristic diagram, the mass flow factor can be calculated according to equations (45) and (21) as

$$W = {Q}_{A} \cdot \frac{Ψ ( {Π}_{R} ( \frac{{p}_{3}}{{p}_{4}} , {Q}_{A} ) )}{{Π}_{R} ( \frac{{p}_{3}}{{p}_{4}} , {Q}_{A} )}$$

and filed in an equally large characteristic diagram

$$W ( \frac{{p}_{3}}{{p}_{4}} , {Q}_{A} ) .$$

This mass flow factor, like the stationary pressure relationship over the annular surface of the wastegate with the simplification globally made for all wastegate turbochargers, is also valid at all stationary operating points.

FIG. 11 illustrates the characteristic diagram of the mass flow factor

$$W ( \frac{{p}_{3}}{{p}_{4}} , {Q}_{A} ) .$$

This characteristic diagram

$$W ( \frac{{p}_{3}}{{p}_{4}} , {Q}_{A} )$$

is strictly monotonic and can be inverted off-line according to Q_{A} into a nominal surface ratio characteristic diagram

$$\vert Q ( \frac{{p}_{3}}{{p}_{4}} , W )$$

and filed in the engine control device. This nominal surface ratio characteristic diagram, with the simplification made globally for all wastegate turbochargers, is also valid in all stationary operating points. The nominal surface ratio Q_{A,sp}, realizing a nominal value of the mass flow factor Wₛₚ, can be selected from this characteristic diagram for the current turbine pressure relationship

$$\frac{{p}_{3}}{{p}_{4}}$$

for said nominal value of the mass flow factor Wₛₚ.

$${Q}_{A , sp} = Q ( \frac{{p}_{3}}{{p}_{4}} , {W}_{sp} ) . \qquad ( 46 )$$

The nominal actuator position can then be determined from the inverted equation (26)

$${s}_{acr , sp} = {Q}_{A , sp} \cdot \frac{{I}_{acr} \cdot {D}_{wg}}{4 \cdot {I}_{wg}} . \qquad ( 47 )$$

By using equations (37) to (39) for the nominal area ratio Q_{A,sp}, the nominal force on the wastegate plate F_{p,sp}, corresponding to this, is determined.

To summarize, from a nominal exhaust gas mass flow \dot{m}_{wg,sp} through the wastegate, the nominal position s_{acr,sp} of the wastegate actuator and the nominal force F_{p,sp} on the wastegate plate required for the implementation of said nominal exhaust gas mass flow can be determined at the running time in the engine control device, from the constant wastegate borehole diameter D_{wg}, the constant wastegate lever length l_{wg},l_{acr}, the constant isoentropic exponent κ, the constant specific gas constant R of the exhaust gas, the current pressure p₃ upstream from the turbine, the current pressure p₄ downstream from the turbine and the current temperature T₃ upstream from the turbine.

The nominal mass flow factor is determined according to equation (45) from the nominal wastegate exhaust gas mass flow \dot{m}_{wg,sp}:

$${W}_{sp} = \frac{{\dot{m}}_{wg , sp}}{{A}_{B} \cdot {p}_{A} \cdot \sqrt{\frac{2 \cdot κ}{( κ - 1 ) \cdot R \cdot {T}_{3}}}} . \qquad ( 48 )$$

According to equation (46) the nominal wastegate surface ratio is read from the nominal wastegate area ratio characteristic diagram, filed in the engine control device:

$${Q}_{A , sp} = Q ( \frac{{p}_{3}}{{p}_{4}} , {W}_{sp} ) . \qquad ( 49 )$$

The final nominal actuator position s_{acr,sp} is determined from equation (47)

$${s}_{acr , sp} = {Q}_{A , sp} \cdot \frac{{I}_{acr} \cdot {D}_{wg}}{4 \cdot {I}_{wg}} . \qquad ( 50 )$$

According to equation (37), the nominal pressure relationship over the annular surface of the wastegate Π_{R,sp} is read from the stored characteristic diagram:

$${Π}_{s , sp} = {Π}_{A , acr} ( \frac{{p}_{3}}{{p}_{4}} , {Q}_{A , sp} ) \qquad ( 51 )$$

According to equations (38) and (39), the internal nominal wastegate pressure p_{wg,sp} and the nominal force on the wastegate plate F_{p,sp} resulting therefrom are

$$\begin{matrix}{p}_{wg , sp} = \frac{{p}_{4}}{{Π}_{A , sp}} & ( 52 ) \\ {F}_{p , sp} = \frac{π}{4} \cdot {D}_{wg}^{2} \cdot ( {ρ}_{wg , sp} - {p}_{4} ) & ( 53 )\end{matrix}$$

Finally, the nominal actuator pressure p_{acr,sp}, required for setting the desired charging pressure and therefrom the wastegate control u_{wg} is calculated from this nominal value combination s_{acr,sp} and F_{p,sp} according to equation (17) for wastegate turbochargers with a pneumatic wastegate actuator without measuring the actuator position:

$${p}_{acr , sp} = {p}_{0} + {F}_{p} ( {p}_{3} , {p}_{4} , {s}_{acr , sp} ) \cdot \frac{{I}_{wg}}{{A}_{acr} \cdot {I}_{acr}} + \frac{k \cdot {s}_{acr , sp} + {F}_{acr , sp}}{{A}_{acr}} \\ {u}_{wg} = f ( {p}_{acr , sp} ) \qquad ( 54 )$$

Alternatively, the calculation chain (48) to (53) can also be used for controlling the wastegate turbochargers with measurement of the wastegate actuator position. A wastegate actuator position control, previously based only on the nominal actuator position s_{acr,sp}, can be made more robust there by taking into consideration the additional nominal force on the wastegate plate F_{p,sp} as a known interfering parameter.

The pre-control of wastegate turbochargers may be improved by employing the methods taught herein. It may differentiate better between various operating states than is possible with precontrol which is not physically based. With that, the respective best control can be calculated and there is less need for a correction of the precontrol by a boosting pressure controller. Overall, the response behavior of the combustion engine is improved.

What is claimed is:

1. A method for controlling an actuator of the wastegate of an exhaust gas turbocharger of a motor vehicle, the method comprising:
characterizing the wastegate in a model as a series connection of two throttle points; and
actuating the wastegate based on the model.

2. The method as claimed in claim 1, further comprising:
filing a characteristic diagram in a memory of an engine control device of the motor vehicle; and
determining the nominal relationship of annular surface to borehole surface of the wastegate as a function of the pressure relationships at the wastegate and as a function of a nominal mass flow factor.

3. The method as claimed in claim 2, further comprising:
calculating the nominal wastegate exhaust gas mass flow at a current operating point during the running time of the exhaust gas turbocharger,
calculating a nominal mass flow factor associated with the current operating point based on the determined nominal wastegate exhaust gas mass flow;
calculating a nominal wastegate-area relationship associated with the current operating point based on the filed characteristic diagram using the determined nominal mass flow factor; and
calculating a nominal position of the actuator to realize a required nominal wastegate mass flow at the current operating point.

4. The method as claimed in claim 3, further comprising:
calculating a nominal force acting on a wastegate plate of the wastegate;
calculating a nominal actuator pressure required to set a desired charging pressure based on the determined nominal position and the determined nominal force; and
calculating a control signal for the actuator based on the nominal actuator pressure calculated.
